(19) United States
(12) Patent Application Publication
(10) Pub. No.: US 2017/0006462 A1
(43) Pub. Date: Jan. 5, 2017

(54) TRIGGERING ASSOCIATIONS BASED ON DETECTION EVENTS

(71) Applicant: Sphero, Inc., Boulder, CO (US)

(72) Inventors: Brandon Dorris, Boulder, CO (US); Jonathan Carroll, Boulder, CO (US)

(21) Appl. No.: 15/189,991

(22) Filed: Jun. 22, 2016

Related U.S. Application Data
(60) Provisional application No. 62/188,651, filed on Jul. 4, 2015.

(51) Int. Cl. H04W 8/18; A63F 13/335; H04W 8/00

(52) U.S. Cl. CPC H04W 8/18; H04W 8/005; A63F 13/335

(57) ABSTRACT

A signal detection system can trigger virtual resource allocation based on detected signals. The signal detection system can detect network devices and perform a lookup to determine whether a UID of a respective network device is associated with a particular item. Such items may include individuals, locations, and various other items, such as virtual resources, in connection with a task-oriented application. As an example, virtual resources may be collected based on such detection events and utilized by a user during task-oriented operations, such as gameplay.

### RELATED APPLICATION

This application claims the benefit priority to U.S. Provisional Patent Application Ser. No. 62/188,651, entitled “Triggering Associations Based on Detection Events,” filed Jul. 4, 2015; hereby incorporated by reference herein in its entirety.

### BACKGROUND

Wireless networks utilize protocols that enable wireless devices to detect signal sources from other devices for initiating data and communication links. Such networks are typically implemented using networking hardware, which may be incorporated in various wireless network devices, such as access points (APs), peer-to-peer (P2P) devices, wireless local area network (LAN) equipped devices, and the like—each advertising a unique identity (e.g., a media access control (MAC) address) indiscriminately to devices within range. Connections may be established with such devices to transmit and receive data.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example signal detection system;

FIG. 2 is a block diagram illustrating an example virtual resource management system utilizing signal detection functions, according to examples described herein;

FIG. 3 is a high level flow chart describing an example process for triggering virtual resource allocation via detection events;

FIGS. 4A-4B are low level flow charts describing example processes for managing virtual resources in connection with signal detection and gameplay;

FIGS. 5A-5C illustrate example use case scenarios implementing one or more example systems and methods described herein;

FIGS. 6A-6B illustrate example devices implementing one or more example systems and methods described herein; and

FIG. 7 is a block diagram that illustrates a computer system upon which examples described may be implemented.

### DETAILED DESCRIPTION

A signal identification system is provided for detecting wireless signals emitted from network devices and recording unique identifiers (UIDs) associated with the detected network devices. The signal identification system can record such UIDs in a local UID log when the detection mechanism detects a respective wireless signal for a respective network device. The respective network device may be any one of an access point, a mobile computing device, a tablet computer, a personal computer, a BLUETOOTH enabled device, a radio-frequency identification device, a local area network enabled device, etc. The signal identification system can further store, either remotely or locally, association information in an association table. The association table can associate UIDs of the network devices with virtual resources in, for example, a gaming environment. When a detection mechanism of the signal identification system detects a respective wireless signal, the signal identification signal can perform a lookup in the association table to determine whether the respective network device is associated with a respective virtual resource.

According to examples, after performing the lookup in the association table and determining that the respective network device is associated with a respective virtual resource, the signal identification system can log a specified quantity of the respective virtual resource in a virtual resource log based on being within wireless range with the respective network device. Additionally or alternatively, in response to determining that the respective network device is not associated with a respective virtual resource, the signal identification system can perform a number of responsive actions. For example, the signal identification system can enter an indication in the association table indicating that the respective network device is not associated with a respective virtual resource. Thus, when the signal identification system eventually connects with a host server over a network, the host server can provide association information corresponding to an association between the respective network device and an associated virtual resource. Alternatively, the signal identification system may be pre-configured to associate unassociated network devices with virtual resources. Thus, upon detecting an unassociated network device, the signal identification system can automatically make an association in accordance with, for example, a predetermined association list or random selection of a finite set of virtual resources.

The signal detection system may be implemented in a resource-based gaming system running a gaming application enabling a user to accumulate, consume, or otherwise utilize the virtual resources in connection with task-oriented functions (e.g., gameplay). In accordance with the gameplay, the gaming system can utilize association information in order to log a specified quantity of an associated resource in a virtual resource log of the memory. The user can employ logged virtual resources to interact in a virtual or augmented reality environment.

As used herein, the term “virtual resource” embodies a computer generated resource representing a real world asset. Such real world assets may include commodities, such as iron ore, crude oil, coal, salt, sugar, tea, coffee beans, soybeans, aluminum, copper, rice, wheat, gold, silver, etc. Other examples of real world assets include natural resources such as biotic resources including wood, food items (e.g., animal products, fish, etc.) and abiotic resources including land, water, air, and other heavy metals. Further examples of real world assets that may be embodied by a “virtual resource” include economic commodities such as the broad spectrum of goods and services. Thus, a “virtual resource” may embody real-world workers or labor, manufactured products, public infrastructure, various services, etc. A “virtual resource” may be expended, traded, distributed, consumed, depleted, sold, auctioned, collected, accumulated, etc., in connection with a task-oriented application implemented on a computing device (e.g., a gaming application, a network-based game, a computer simulation, and the like).

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules or components of a system. A programmatic module or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein can be implemented, in whole or in part, on computing devices such as digital cameras, digital camcorders, desktop computers, cellular or smart phones, personal digital assistants (PDAs), laptop computers, printers, digital picture frames, and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a non-transitory computer usable carrier medium capable of carrying such a program.

System Description

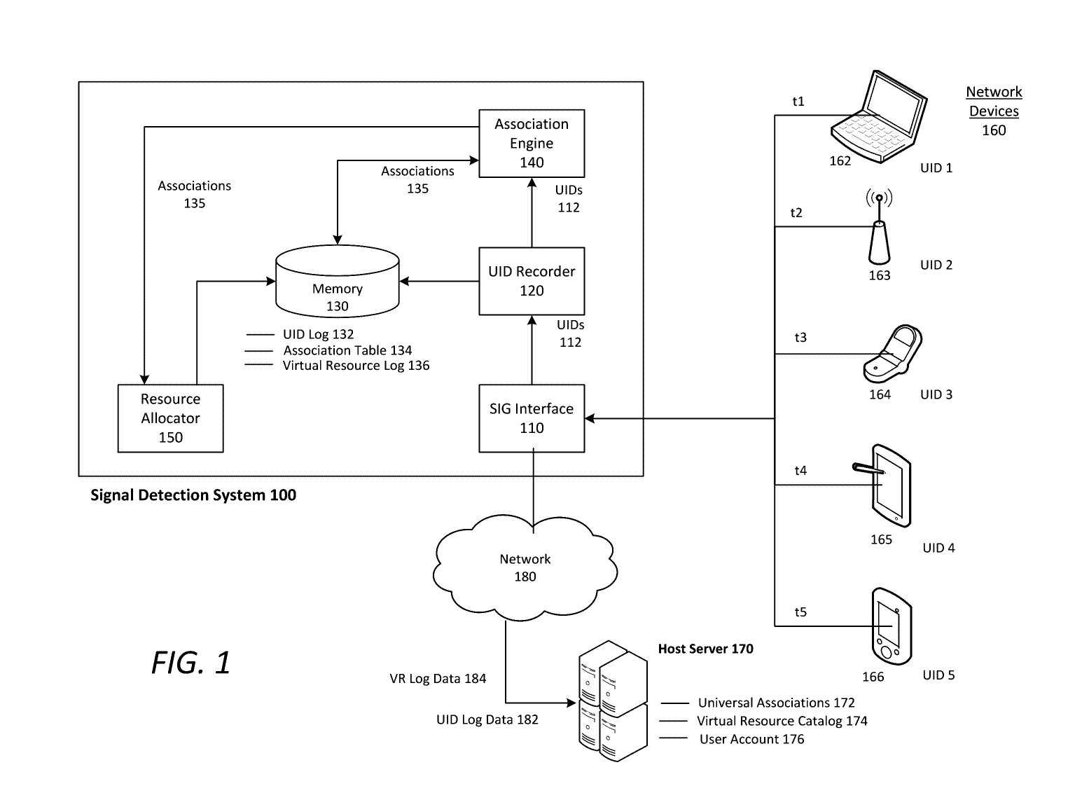

FIG. 1 is a block diagram illustrating an example signal detection system. The signal detection system 100 may be a standalone device or may be incorporated in a mobile computing device running an application specific to detecting and recording signals from network devices. Standalone devices may include a pocket device, such as a key fob, that incorporates one or more features discussed in connection with the signal detection system 100 of FIG. 1. For mobile computing environments, the signal detection system 100 may utilize mobile computing device resources, such as device hardware/firmware, or operate utilizing a combination of hardware and software. For example, the signal detection system 100 may be enabled upon initiation of an application on the mobile computing device. Additionally or alternatively, the signal detection system 100 may continue to run during hibernation or sleep mode of the application using background or standby resources. Alternatively, the signal detection system 100 may be enabled on a remotely operated device under control of a remote controller, such as a mobile computing device running a control application to operate the remotely operated device.

Referring to FIG. 1, the signal detection system 100 can include a signal interface 110 to detect emitted signals from any number of network-enabled devices 160. Such emitted signals may be background signals advertising the presence and media access control (MAC) addresses of such devices 160. For example, at time t1, the signal detection system 100 may be within wireless range of a laptop computing device 162 having a unique identifier UID 1. The UID of the laptop computing device 162 (i.e., UID 1) may correspond to the MAC address of the laptop computing device 162. The signal detection system 100 can include a UID recorder 120, which can receive UIDs 112 from the signal interface 110 and record the respective UIDs 112 in a UID log 132 of a local memory resource 130. Accordingly, the UID recorder 120 can log the laptop computing device's 162 UID (i.e., UID 1) in the UID log 132.

As a further example, at time t2, the signal detection system 100 may come within wireless range of an access point 163 having a MAC address UID 2. According to examples described herein, the signal interface 110 can receive the MAC address of the access point 163. For example, the signal interface 110 can receive a beacon from the access point 163 which includes the access point's 163 MAC address (UID 2). The signal interface 110 can communicate UID 2 to the UID recorder 120, which can log UID 2 in the UID log 132.

According to some examples, the signal detection system 100 can establish a network connection, e.g., via network 180, with a host server 170. Upon connecting with the host server 170, the signal detection system 100 can transmit UID log data 182 from the local UID log 132 to the host server 170. Accordingly, the host server 170 can compile the UID log data 182 and associate the respective UIDs 112 from the log data 182 with a user account 176 associated with a user of the signal detection system 100. In such examples, the remote host server 170 can perform any number of functions described herein. For example, the host server 170 can utilize the UID log data 182 from the signal detection system 100 to identify the network devices (i.e., the laptop computing device 162 and the access point 163) with which the signal detection system 100 came within wireless range.

The host server 170 can store a universal association list 172 that may list associations between, for example, UID 1 of the laptop computing device 162 and a specified virtual resource. Accordingly, the host server 170 can attribute an amount of the specified virtual resource associated with UID 1 to the user account 176 associated with the signal detection system 100. Thus, if the specified virtual resource associated with UID 1 was, for example, a virtual ore, then the host server 170 could attribute a predetermined amount of virtual ore to the user account 176.

Additionally or alternatively, the host server 170 may perform a lookup in the universal associations list 172 and identify that UID 2 (corresponding to the access point 163) does not yet have an associated virtual resource. Thus, the host server 170 may select, either sequentially or randomly, a virtual resource from a virtual resource catalog 174 and log a new association between the selected virtual resource and UID 2 in the universal associations list 172. Accordingly, an amount of the new selected resource can be attributed to the user account 176, in which respective virtual resources may be accumulated based on wireless detection events between the signal detection system 100 and the network devices 160.

Additionally or alternatively, one or more operations described with respect to the host server 170 may be performed by the signal detection system 100 itself. For example, the signal detection system 100 can include an association engine 140 which, upon detection of a wireless signal from a network device 160, can determine whether that device is locally associated with a virtual resource. Thus, the memory resource 130 of the signal detection system 100 can include an association table 134 which may include predetermined associations 135 between the network devices 160 and virtual resources. As an example, at time t3, the signal detection system 100 can come within wireless range of a mobile device 164, which can announce its presence using MAC address UID 3. The signal interface 110 can receive UID 3, and the association engine 140 can perform a lookup in the association table 134 to determine whether UID 3 is associated with a particular virtual resource (e.g., virtual oil). Thus, the signal detection system 100 may flag the association between UID 3 and virtual oil until a connection with the host server 170 is established to attribute the virtual oil to the user account 176.

Alternatively, the signal detection system 100 can include a resource allocator 150 and the memory resource 130 can include a virtual resource log 136, comprising an accumulation of the virtual resources collected by the user. The association engine 140 can transmit the associations 135 to the resource allocator 150, which in turn, can select and compile respective amounts of accumulated virtual resources (e.g., 5 units of virtual oil corresponding to the UID 3 detection event) in the virtual resource log 136.

According to one or more examples, at time t4, the signal detection system 100 may come within range of a tablet computing device 165. UID 4, associated with the MAC address of the tablet computing device 165 may be received by the signal interface 110 and communicated to the association engine 140, which can determine from the association table 134 that UID 4 is associated with, for example, virtual coal. The association engine 140 can communicate the UID 4 association to the resource allocator 150, which can log an amount of virtual coal in the virtual resource log 136. Additionally or alternatively, if the virtual resources (e.g., virtual coal) of all recently detected devices 160 are logged in the virtual resource log 136, the signal detection system can flush the UID log 132, since the UIDs of the network devices 160 are already known and associated in the association table 134.

Upon network connectivity with the host server 170 over the network 180, the signal detection system can transmit virtual resource log data 184 to the host server 170 to enable the host server 170 to attribute collected virtual resources to the user account 176 associated with the user of the signal detection system 100. Various alternatives are contemplated. For standalone devices, the signal detection system 100 can communicatively couple with a user's computing device, such as a smartphone or tablet computer. The virtual resource log data 184 may then be communicated to the user's computing device which can, in turn, attribute the collected virtual resources to the user's account locally or via network connection to the host server 170. The collected virtual resources may be expended as a result of gameplay, or via various incentive-based programs increasingly prevalent in the mobile application marketplace to induce users to interact with stipulated content.

Additionally or alternatively, the consumption, accumulation, and/or expenditure of collected virtual resources may be performed dynamically in connection with task-oriented operations (e.g., gameplay) on a mobile computing device running a respective application utilizing such virtual resources. Further, a standalone signal detection system 100 (e.g., a key fob device) may incorporate near field communication (NFC) technology such that the supplementary task of collecting virtual resources may be performed during a user's routine daily activities, and the user can compile the virtual resources via NFC link with the user's computing device.

In accordance with the above examples, at time t5, the signal detection system 100 may come within range of a mobile device 166 having a unique identifier (e.g., MAC address) UID 5. The signal interface 110 can communicate the mobile device's 166 identifier to the UID recorder 120 which can record UID 5 in the UID log 132 of the local memory resource 130. The mobile device's 166 identifier may be further communicated to the association engine 140 which can perform a lookup in the association table 134 to determine whether UID 5 is associated with a virtual resource.

If UID 5 is not associated with a virtual resource, the signal detection system 100 can subsequently utilize the UID log 132 to communicate UID log data 182 to the host server 170 to receive an association between UID 5 and a virtual resource. Alternatively, the signal detection system 100 can include a local virtual resource catalog, similar to the virtual resource catalog 174 of the host computer 170, and can perform a sequential or randomized selection of a virtual resource (e.g., virtual wood) to associate with UID 5.

If UID 5 has already been associated with a virtual resource (e.g., virtual wood), as resultant from the lookup performed by the association engine 140, then the association 135 can be communicated to the resource allocator 150, which can allocate a predetermined amount of virtual wood in the virtual resource log 136. Once a connection between the signal detection system 100 and the host server 170 is established, the virtual resource log data 184, which can comprise the accumulated virtual resources since the last established connection, can be communicated to the host server 170 for attribution to the user's account 176. Once the virtual resource log data 184 is communicated, the virtual resource log 136 in the signal detection system 100 can be flushed.

Various limitations to resource allocation are realized. For example, the signal interface 110 of the signal detection system 100 may be restricted to only receive virtual resources associated with network devices 160 upon establishing a connection with the respective device, as opposed to merely detecting the network device 160. Furthermore, the allocated amounts of a particular virtual resource associated with multiple network devices 160 may be diverse. For example, the resource allocator 150 may allocate more virtual resources when the signal detection system 100 comes within contact of a less accessible access point (e.g., an access point at a remote location). Furthermore, at any given expiration time (e.g., after an expiration period or a time-limited gaming session), the UID log 132, the association table 134, and/or the virtual resource log 136 may be reset or otherwise reconfigured.

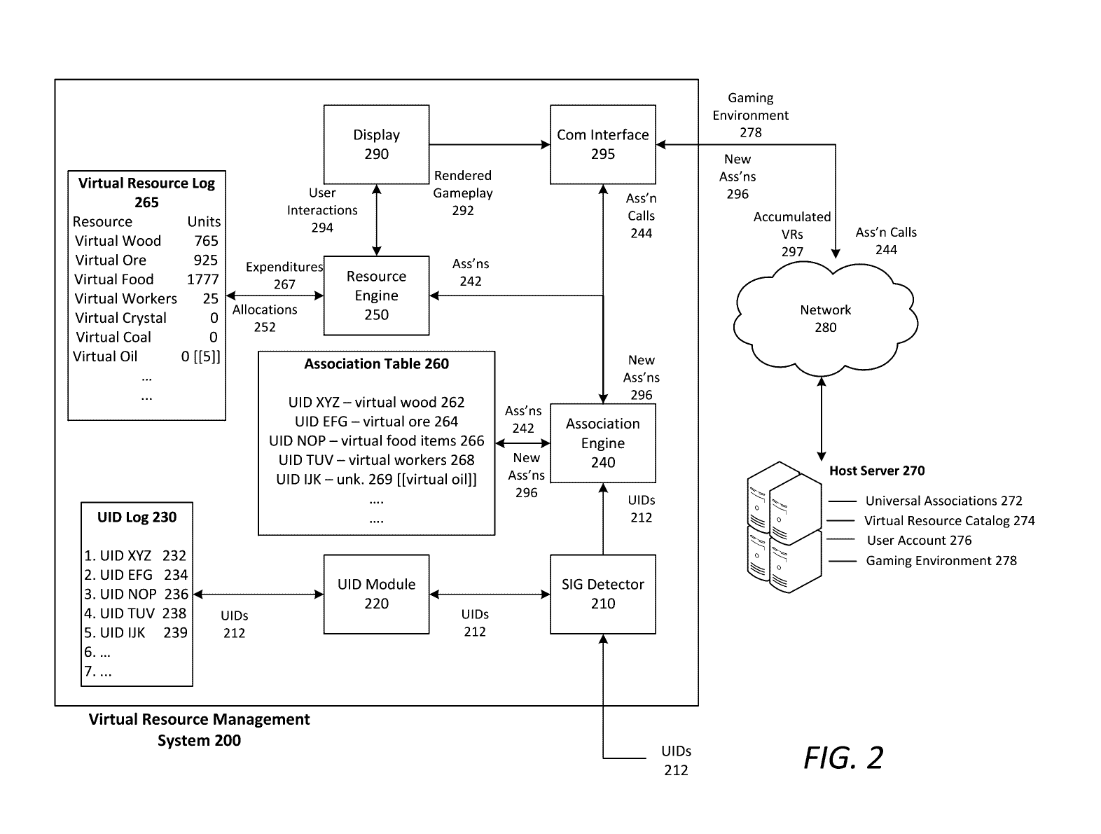

FIG. 2 is a block diagram illustrating an example virtual resource management system 200 utilizing signal detection functions, according to examples described herein. The virtual resource management system 200 can include features from the signal detection system 100 described with respect to FIG. 1. Furthermore, one or more components of the virtual resource management system 200 may be comprised in any number of electronic devices, such as smartphones, tablet computers, personal computers, laptop devices, wearable computing systems, and the like. Accordingly, the virtual resource management system 200 can comprise an application-based program running on any of such devices, enabling a user to collect, accumulate, expend, and consume virtual resources in connection with task-oriented operations performed on the device. For example, the user's device may run an application specific to virtual resource gameplay, rendering a gaming environment 278 on a display 290. The user may perform interactions 294 using the display 290 in order to utilize compiled virtual resources in the virtual resource log 265, as shown in FIG. 2.

Referring to FIG. 2, the virtual resource management system 200 can include a signal detector 210 to detect UIDs 212 of various network devices, as discussed above with respect to FIG. 1. The UIDs 212 may be logged in a UID Log 230 by a UID module 220. As shown in FIG. 2, various UIDs (i.e., UID XYZ 232, UID EFG 234, UID NOP 236, UID TUV 238, and UID IJK 239), each associated with a respect network device, have been logged in the UID log 230. The UIDs 212 may be communicated to an association engine 240, which can perform lookups in an association table 260 to determine whether a respective UID is associated with a respective virtual resource. Thus, in the example shown in FIG. 2, UID XYZ 232 is associated with the virtual resource, virtual wood 262, UID EFG 234 is associated with virtual ore 264, UID NOP 236 is associated with virtual food items 266, and UID TUV 238 is associated with virtual workers 268.

In accordance with examples described herein, when the signal detector 210 detects say, an access point corresponding to UID NOP 236, UID NOP 236 may be communicated to the association engine 240, which, upon performing a lookup in the association table 260, can determine that UID NOP 236 is associated with virtual food items 266. The association engine 240 can communicate this association 242 to a resource engine 250, which can log allocations 252 of virtual resources in a virtual resource log 265, as shown in FIG. 2. Thus, once the association engine 240 communicates the association of UID NOP 236 with virtual food items 266 to the resource engine 250, the resource engine 250 can allocate a predetermined amount of virtual food 266 in the virtual resource log 265. As shown in the virtual resource log 265 of FIG. 2, the user has accumulated 1777 units of virtual food 266, in addition to 765 units of virtual wood 262, 925 units of virtual ore 264, and 25 units of virtual workers 268. However, the user has yet to accumulate any virtual crystal, virtual coal, or virtual oil, which may be essential items in connection with the rendered gameplay 292 on the display.

Continuing with examples provided herein, as the user comes within range of say, a remote access point associated with UID IJK 239, the signal detector 210 can communicate UID IJK 239 to the association engine 240, which upon performing a lookup in the association table 260, can determine that UID IJK 239 is not yet associated with a virtual resource (i.e., unknown 269). In accordance with examples described herein, the association engine 240 may attribute UID IJK 239 with a particular virtual resource (e.g., virtual oil) by referencing a local virtual resource catalog, similar to the virtual resource catalog 274 of the host server 270. Alternatively, the association engine 240 may compile an association call 244, which can be communicated to the host server 270 upon establishing a network connection via network 280. The host server 270 can sequentially or randomly select a virtual resource (e.g., virtual oil), from the virtual resource catalog 274, and log the new association between UID IJK 239 and virtual oil in a universal associations list 272. The host server 270 can respond to association calls 244 with new associations 296 logged in the universal associations list 272. The new associations 296 can be communicated to the virtual resource management system 200 over the network 280 via a communication interface 295 of the virtual resource management system 200. Accordingly, the new associations 296 can be received by the association engine 240, which can log the new associations 296 in the association table 260.

Thus, in the example described, the association between UID IJK 239 and virtual oil may be transmitted through the communication interface 295 of the virtual resource management system 200 to the association engine 240, which can update the association table 260 to replace “unknown 269” with virtual oil.

Furthermore, the resource engine 250 can manage the resource log 265 based on both user interactions 294 performed via the rendered gameplay 292 on the display 290, and detected UIDs 212 and received associations 242 based on such UIDs 212. In various implementations, the user interactions 294 in connection with the rendered gameplay 292 can cause virtual resources stored in the virtual resource log 265 to be expended. Such expenditures 267 in the rendered gameplay 292 can correlate to a depletion of the relevant virtual resource in the virtual resource log 265. Various related examples are contemplated. For example, the user interactions 294 can cause respective virtual resources to be traded, consumed, accumulated, invested, or expended in accordance with the rendered gameplay 292.

In the provided example above, the detection of UID IJK 239—now associated with virtual oil—can cause the resource engine 250 to attribute a predetermined amount of virtual oil (e.g., 5 units) in the virtual resource log 265. Furthermore, as shown in FIG. 2, user interactions 294 in connection with the rendered gameplay 292 can cause dynamic updates, by the resource engine 250, to the virtual resource log 265. The virtual resource log 265 can be dynamic in nature, in connection with the rendered gameplay 292 and the detection of UIDs 212. The resource engine 250 can continuously perform allocations 252 and expenditures 267 of virtual resources in the virtual resource log 265. Additionally or alternatively, the resource engine 250 can communicate accumulated virtual resources 297 to the host server 270, which may attributed the accumulated virtual resources 297 to the user's account 276 to save progress data corresponding to the rendered gameplay 292.

The rendered gameplay 292 may be application or software-based utilizing any number of resources of the user's computing device. The rendered gameplay 292 may be provided in connection with augmented reality, virtual reality, or a virtually generated gaming environment 278 provided by the host server 270. For augmented reality implementations, the gaming environment 278 provided can comprise virtual features rendered in a real world environment. For example, a camera included on the user's computing device may be utilized to capture real-world images or video, and the gaming environment 278 may be rendered thereon. Furthermore, the rendered gameplay 292 may be incorporated in conjunction with the use of a remotely operated self-propelled device. In such implementations, the rendered gameplay may include virtual controls to remotely control the self-propelled device. Accordingly, the virtual resource management system 200 can operate in connection with the self-propelled device, which can incorporate one or more features of the virtual resource management system 200, such as the signal detection features (i.e., signal detector 210, UID module 220, and UID log 230).

Methodology

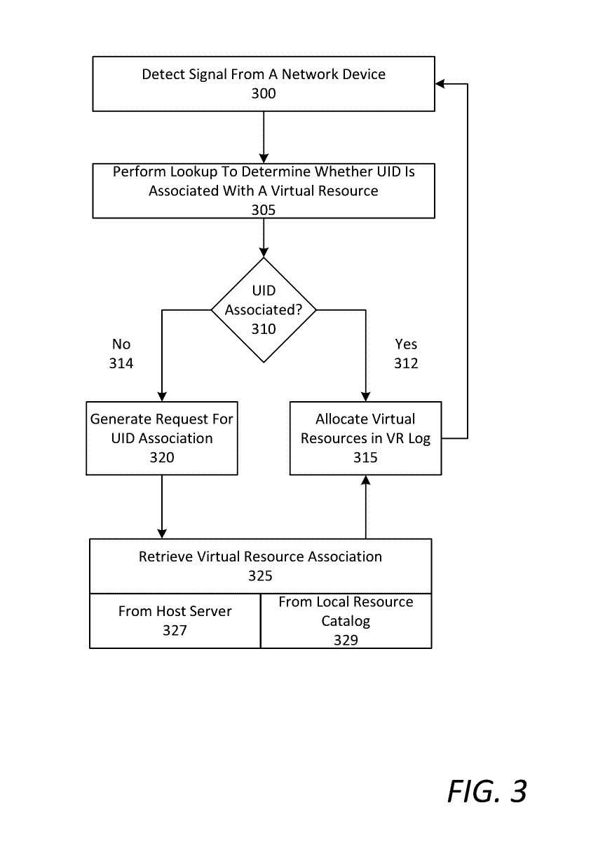

FIG. 3 is a high level flow chart describing an example process for triggering virtual resource allocation via detection events. In the below discussion of FIG. 3, reference may be made to like reference characters representing various features of FIG. 1 for illustrative purposes. Furthermore, the low level method described in connection with FIG. 3 may be performed by, for example, the signal detection system 100 as illustrated in FIG. 1. Referring to FIG. 3, the signal detection system 100 can initially detect a signal, such as an advertising beacon, from a network device, such as an access point (300). The beacon can include the network device's MAC address, or other UID representing the network device.

The signal detection system 100 can then perform a lookup in an association table 134 to determine whether the UID is associated with a given virtual resource (305). At decision block (310), the signal detection system 100 identifies from the association table 134 whether the UID is associated. If the UID is associated with a given virtual resource (312), then the signal detection system 100 can allocate a predetermined amount of the given virtual resource in the virtual resource log 136 (315), and the process can begin again with the detection of another signal from another network device (300). However, if the UID is not associated with a virtual resource (314), then the signal detection system 100 can generate a request for a UID association (320), and retrieve the virtual resource association (325). In some examples, the generated request may be transmitted to a host server 170, and therefore the virtual resource association may be retrieved from the host server (327). Alternatively, the generated request may be serviced locally via a selection from a local virtual resource catalog (329). Accordingly, once the UID is associated with a virtual resource the signal detection system 100 can allocate the virtual resource in the virtual resource log 136 (315), and the process can begin again.

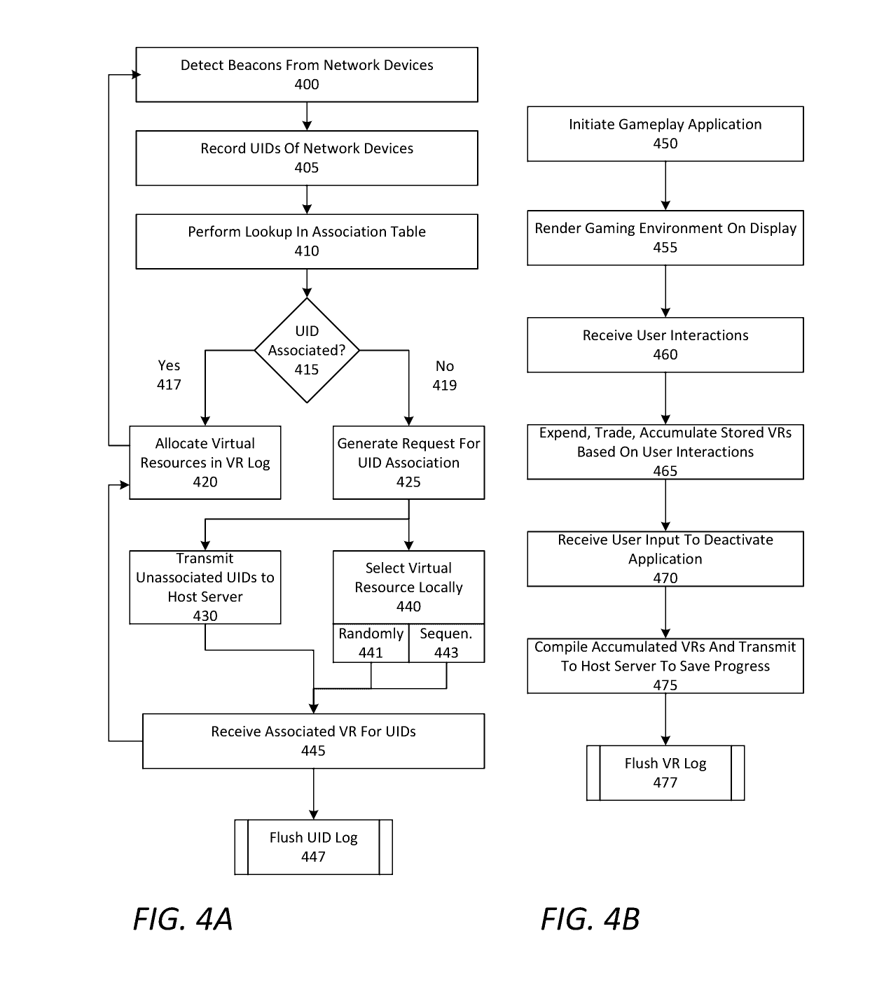

FIGS. 4A-4B are low level flow charts describing example processes for managing virtual resources in connection with signal detection and gameplay. In the below discussion of FIGS. 4A-4B, reference may be made to like reference characters representing various features of FIG. 2 for illustrative purposes. Furthermore, the low level method described in connection with FIGS. 4A-4B may be performed by, for example, the virtual resource management system 200 as illustrated in FIG. 2. Referring to FIG. 4A, the virtual resource management system 200 can detect advertising signals (e.g., beacons) from network devices (400). Such advertising signals may include UIDs, such as MAC addresses for the detected network devices. The virtual resource management system 200 can then record the UIDs of the network devices in the UID log 230 (405).

The virtual resource management system 200 may perform a lookup in the association table 260 (410) to determine whether a respective UID is associated with a respective virtual resource (415). If the respective UID is associated with a respective virtual resource (417), then the virtual resource management system 200 can allocate a predetermined amount of the respective virtual resource in the virtual resource log 265 (420). Thereafter, the process may begin again with the detection of advertising signals from network devices (400). However, if the respective UID is not associated with a respective virtual resource (419), the virtual resource management system 200 can generate a request, or an association call 244, to create a new association 296 for the respective UID (425).

The virtual resource management system 200 can transmit the request to the host server 270 when a network connection is established (430). Alternatively, the virtual resource management system 200 can locally select a respective virtual resource from a local virtual resource catalog (440). Such a selection may be made sequentially (443), for example, if the virtual resource catalog is a sequential list of virtual resources. Or, the selection may be made randomly (441) from the virtual resource catalog by way of a random selection technique.

In various implementations, the virtual resource management system 200 can receive, remotely or locally, associated virtual resources for unassociated UIDs (445). Thus, the respective unassociated UID may be associated with a respective virtual resource, and thereafter the virtual resource management system 200 can allocate a predetermined amount of the respective virtual resource in the virtual resource log 265 (420). After all detected UIDs are associated with their respective virtual resources, the virtual resource management system 200 can flush the UID log 230, since storing the UIDs may no longer be necessary.

The process as described in connection with FIG. 4B may be performed before, after, or in conjunction with the process as described with respect to FIG. 4A. Referring to FIG. 4B, the virtual resource management system 200, may receive a user input (e.g., via a touch input on a touch-sensitive display) to launch a gaming application associated with trading, consuming, accumulating, earning, investing, or otherwise expending virtual resources. Based on the user input, the virtual resource management system 200 can initiate the gameplay application (450). In doing so, the gaming environment may be rendered on the display 290 (455).

During gameplay, the virtual resource management system 200 can receive various user interactions 294 in connection with the gameplay (460). Such user interactions 294 may be performed by way of touch inputs, mouse interactions, keyboard interactions, interactions using a game controller such as a joystick or a specialized controller device, or a combination of the above. Furthermore, such user interactions 294 may be performed in connection with remote operation of a remotely operated device. In accordance with examples described herein, the gameplay can incorporate a virtual or augmented reality environment in which the user can utilize collected virtual resources. For example, collected virtual resources may be consumed by a virtual character under operative control of the user. Additionally or alternatively, selected virtual resources can be expended to build a virtual building or town. Collected virtual food items may be utilized to feed a virtual colony of gameplay characters. Virtual oil may be utilized by the user during gameplay to modernize a primitive society. Virtual workers may be employed for production or to build infrastructure. Various alternatives and additions in connection with task-oriented operations and gameplay are contemplated.

Accordingly, based on the user interactions 294, the resource engine 250 of the virtual resource management system 200 can dynamically modify or update the virtual resource log 265 to enable the user to expend, trade, accumulate, invest, earn, etc. virtual resources from the virtual resource log 265 (465).

When the user wishes to end a gameplay session, the virtual resource management system 200 may receive a user input to deactivate the gaming application (470). In order to save gameplay progress, the resource engine 250 of the virtual resource management system 200 can compile the virtual resources left in the virtual resource log 265, and transmit a saved list of virtual resources to the host server 270 (475). Thereafter, the virtual resource management system 200 may flush the virtual resource log (477), since the progress is remotely saved.

Use Case Scenarios

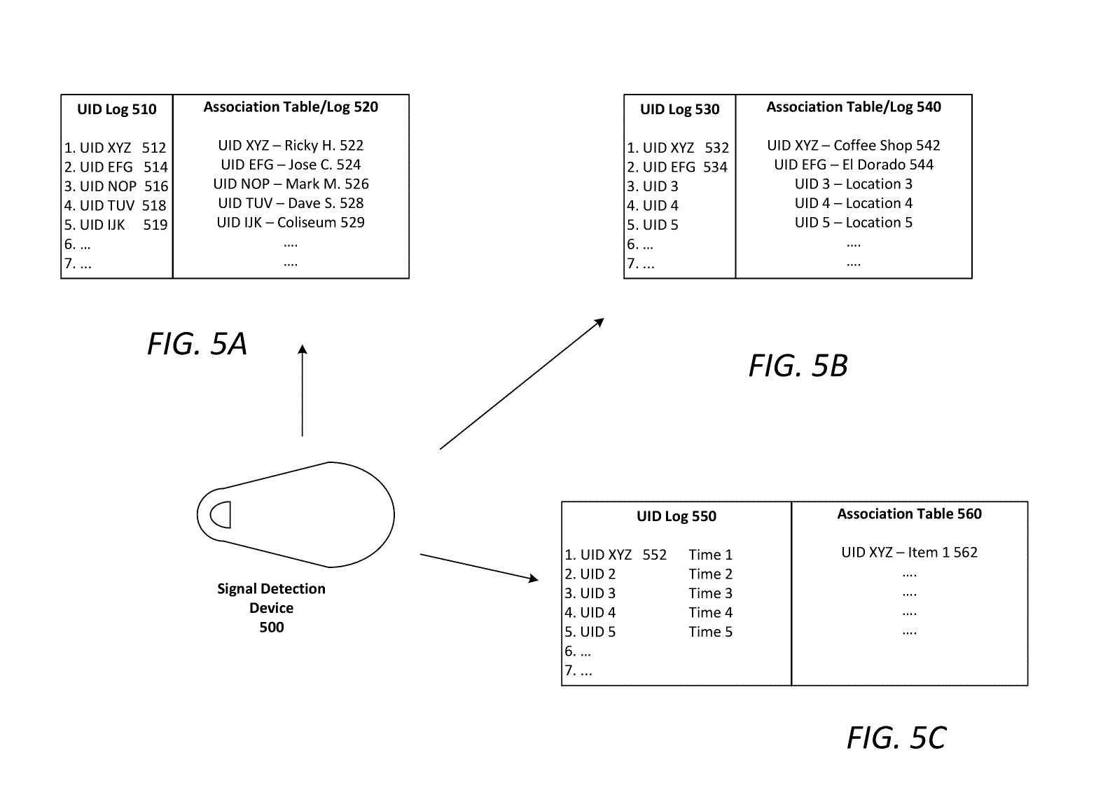

FIGS. 5A-5C illustrate example use case scenarios implementing one or more example systems and methods described herein. Various implementations of the disclosed systems and method described herein are contemplated. For example, the detected MAC address of various network devices may be associated with any number of plausible items. Such items may be individuals associated with the network device (e.g., an owner of the network device), or such items may be associated with persons of interest (e.g., characters in connection with a gaming environment), as illustrated in FIG. 5A. Alternatively, such items may be locations of the respective network devices, such that a user is enabled to identify where he/she has traveled, as illustrated in FIG. 5B. Additionally or alternatively, such items may be associated with a time stamp, thereby enabling a user to determine that an interaction has taken place with a particular network device and a time in which the interaction took place, as illustrated in FIG. 5C.

Furthermore, the examples provided with respect to FIGS. 5A-5C may be implemented using the signal detection system 100 as described with respect to FIG. 1, and/or using a modified virtual resource management system 200 as discussed with respect to FIG. 2.

Referring to FIG. 5A, a UID Log 510 of a signal detection system 500 can compile UIDs (e.g., UID XYZ 512, UID EFG 514, UID NOP 516, UID TUV 518, UID IJK 519, etc.) associated with respective network devices. The respective network devices may be any one of an access point, a mobile computing device, a tablet computer, a personal computer, a BLUETOOTH enabled device, a radio-frequency identification device, a local area network enabled device, etc. Furthermore, a user may carry the signal detection device 500, which can come within wireless detection range of any number of the foregoing network devices. In accordance with examples described herein, the signal detection device 500 can compile UIDs corresponding to the network devices in a UID Log 510.

In many examples, the signal detection device 500 only compiles UIDs associated with network devices in which the user come within wireless range. In such examples, the user may enable a function on a computing device (e.g., a tablet computer, smart phone, PC, etc.), which can pull the UIDs from the signal detection device 500 and make associations according to a local association table. In order to transmit the UIDs to the user's computing device, the signal detection device 500 can include connectivity functions to establish a connection with the computing device (e.g., Wi-Fi, BLUETOOTH, etc.). Alternatively, the signal detection device 500 can include inductive data communication capabilities in order to transmit the UIDs to the computing device over an inductive link.

Alternatively, the signal detection device 500 can include a local association table 520 in order to make a given association when the signal detection device 500 comes within wireless range of a given network device. Upon each detection event, the association table 520 of the signal detection device 500 can log an association. For example, as the user carries the signal detection device 500 within wireless range of an access point, the signal detection device 500 can receive the access point's advertising beacon, which can include the access point's unique identifier, UID XYZ 512. The signal detection device's 500 association table 520 can be referenced to identify that UID XYZ is associated with Ricky H. 522—who may be an owner of the access point. The user may then journey within range of a wireless device with UID EFG 514, which the association table 520 may associate with Jose C. 524—an owner of the wireless device. In such implementations, after an excursion in which the user encounters any number of network devices, the user may thereafter review the association table/log to identify the individuals (i.e., Ricky H., Jose C., etc.) whose devices the user encountered during the excursion.

Alternatively, for task-oriented implementations (e.g., gaming), the association table may associate such UIDs with characters or places in a gaming environment. As contemplated in one or more examples, each detection event can correspond to a meeting or visitation in which the user meets with a character or visits a point of interest. A task-oriented application may require the user to meet a certain character or visit a certain place before a next achievement is reached. Accordingly, along a physical excursion by the user, the signal detection device 500 may detect advertising beacons for respective devices associated with UID NOP 516, UID TUV 518, and UID 519. The association table 520 may be referenced to identify characters and/or places (real or virtual) with which the respective network devices are associated. As an example, the association table/log 520 can identify Mark M. 526 as being associated with UID NOP 516, Dave. S. 528 as being associated with UID TUV 518, and the Coliseum 529 as being associated with UID IJK 519. Upon transmitting such characters and/or places to the user's computing device, the task-oriented application can input such meetings and visits and record a number of respective achievements.

FIG. 5B illustrates another usage scenario in which the UIDs of network devices may be associated with a real-world or mock-world environment. As an example, the user may carry the signal detection device 500 to within wireless range of an access point of a coffee shop, where the access point has a unique identifier UID XYZ 532. The signal detection device 500 can log UID XYZ in the UID Log 530 and reference the association table/log 540 to determine that UID XYZ 532 is associated with the coffee shop 542. After an excursion of passing through any number of wireless beacons, the user can map the excursion using the physical locations, logged in the association table/log 540, of the network devices along the way.

In some examples, the physical locations of the network devices may be determined via the detected beacon, which may include a location information. Alternatively, the signal detection device 500 can include location-based functionality (e.g., GPS resources) to log the location in the association table/log 540. Accordingly, in response to a detection event, the signal detection device 500 can be triggered to pinpoint the physical location of the detection event—which can be logged along with the UID of the network device, as shown in FIG. 5B.

In other examples, the location associated with a UID may be based on a mock-world environment corresponding to, for example, a gaming environment. For example, a user may interact with a task-oriented application on a computing device, which may require the user to visit El Dorado 544. The user may then physically search for or journey to a specified network device having UID EFG 534, which, in accordance with the association table, is associated with El Dorado 544. In such examples, the user may be enabled to reference the association table 540, which may provide a physical location in the real-world of the network device associated with El Dorado 544. Thus, upon wirelessly contacting the network device having UID EFG 534, the association table/log 540 can log the detection event, and the user can accomplish a next achievement in the task-oriented application.

Additionally, in combination with the above examples with respect to FIGS. 5A and 5B, the signal detection device 500 may also include a timer or clock to enter a timestamp as triggered by a detection event, as illustrated in FIG. 5C. Thus, a user may further review a time in which the signal detection device 500 detected the wireless signal of a respective wireless device. For example, during a given excursion, the user may come within wireless range of a network device having UID XYZ 552, which can be logged as being associated with Item 1 562. The detection event of UID XYZ 552 can further trigger a clock or timer to log a timestamp associated with the detection event. The time may reflect a local or universal time, or may reflect an elapsed time from say, the beginning of the excursion or a start time of the task-oriented application.

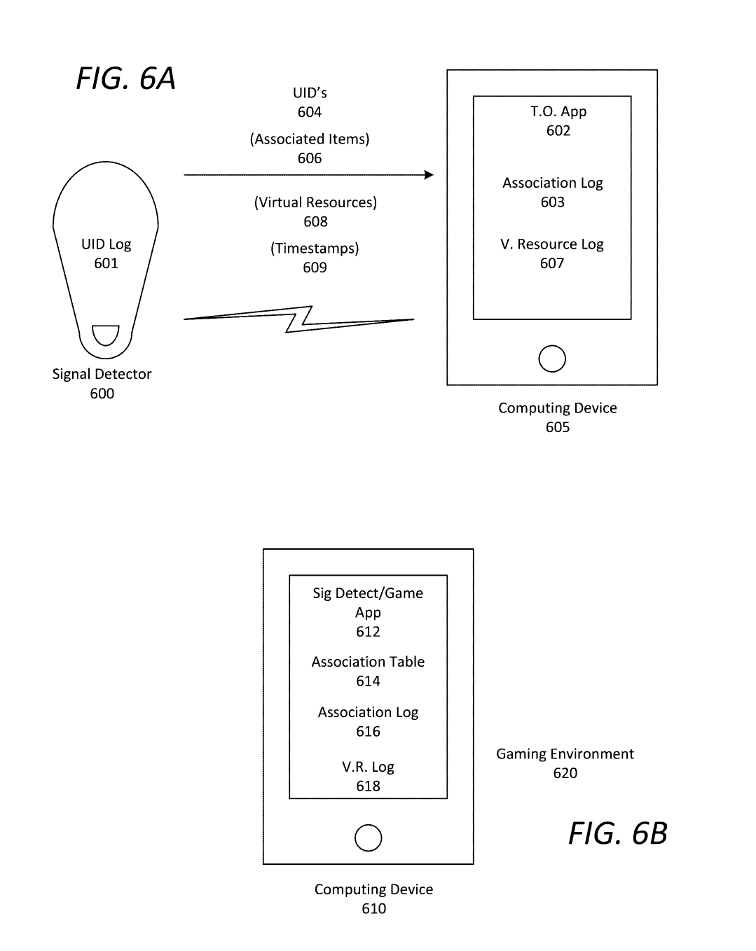

FIGS. 6A-6B illustrate example devices implementing one or more example systems and methods described herein. Referring to FIG. 6A, a signal detector 600 may be carried by a user to detect advertising beacons or wireless signals from various network devices. The signal detector 600 can include a UID Log 601 and automatically log each UID (e.g., MAC address) corresponding to each wireless device detected. According to many examples, upon linking with a computing device 605, the signal detector 600 can transmit the UID's 604 from the UID Log 601 to the computing device 605. The link may be any data connection. For example, the signal detector 600 can include functionality corresponding to Wi-Fi, radio-frequency, infrared, BLUETOOTH, near-field communication (NFC), and the like. Thus, the UID's 604 may be transmitted to the computing device 605 over such a communication link.

In accordance with examples discussed with respect to FIGS. 5A-5C, the signal detector 600 can collect UIDs corresponding to various network devices, which may be associated with any number of items. For example, an association table of either the computing device 605 or the signal detector 600 can include associations between UIDs of network devices and the registered owners of those network devices. Thus, upon detection of such network devices, the registered owner may be logged in an association log 603. In such examples, a user may scroll through the association log 603 to identify individual with which the user came into wireless contact.

In variations, the association table of either the signal detector 600 or the computing device 605 can associate various network devices with real-world or mock-world characters, landmarks, or other places. Such associations may be made in connection with a task-oriented application 602, such as a gaming application providing a gaming environment.

In some examples, the signal detector 60 can itself include an association table/log and/or a virtual resource log to perform and log associations and collect virtual resources. In such examples, logged association items 606 and/or collected virtual resources 608 may also be transmitted to the computing device over the communication link. Furthermore, timestamps 609 correlated to the detection events and logged associated items 606 may also be transmitted to the computing device 605.

In similar implementations, the computing device 605 may run a task-oriented application 602, which can trigger the communication link with the signal detector 600. Execution of the task-oriented application 602 can correspond to running a game providing a gameplay environment which utilizes items associated with the UID's 604 of network devices. The task-oriented application 602 can cause the computing device 605 to receive the UID's 604 from the signal detector 600 and reference an association log 603 to determine whether a given UID is associated with a given association item. If the given UID is not associated, the computing device 605 can create an association or retrieve an association from a host server. Given an association, the computing device 605 can log a specified amount of collected virtual resources in a local virtual resource log 607 for use in the task-oriented application 602.

Referring to FIG. 6B, a computing device 610 can run a task-oriented application, or gaming application 612 that includes the signal detection functions of the signal detector 600 of FIG. 6A. According to one or more examples, a user may run the gaming application 612 on the computing device 610. The user may interact with the computing device 610 via the gaming application 612, which can provide a gaming environment 602 that requires the use, directly or indirectly, of an association table 614 in connection with the signal detector of the gaming application 612. For example, the gaming environment 620 may require user interactions with real-world or mock-world characters and/or places, which may be accomplished by coming within wireless range of specified network devices associated with such real-world or mock-world characters and/or places in an association table 614 of the computing device 610. Upon detecting such network devices, the computing device 610 can log associated items (e.g., real-world characters, mock-world characters, real-world locations, mock-world locations, etc.). In accordance with the gaming environment 620, upon logging such associations, various tasks may be achieved.

In similar examples, the gaming environment 620 may require the collection and use of virtual resources, as described above. Thus, the user may run the signal detector/gaming application 612 and interact with the gaming environment 620, which may require the user to collect a number and amount of virtual resources. Accordingly, the user can perform a physical excursion to enable the computing device 610 to wirelessly interact or otherwise detect various network devices to collect such virtual resources for utilization in the gaming environment 620. The gaming environment 620 can provide a virtual resource log 618 which can inform the user of which virtual resources and how many of each virtual resource the user has collected.

Hardware Diagram

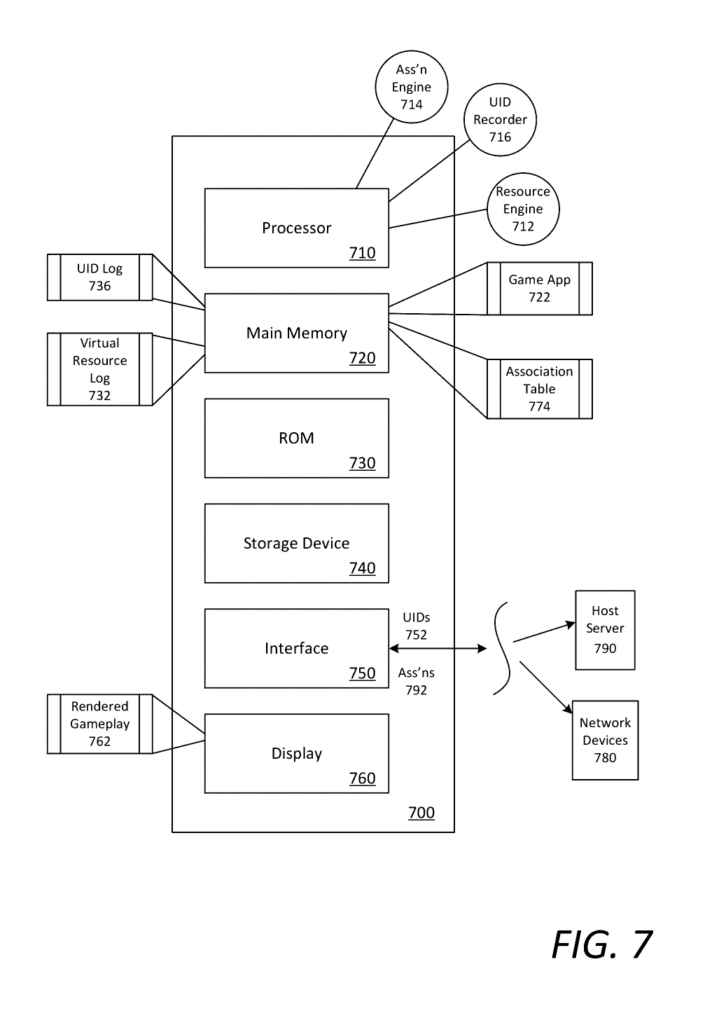

FIG. 7 is a block diagram that illustrates a computer system upon which examples described may be implemented. For example, one or more components discussed with respect to the systems and the methods described herein may be performed by the system 700 of FIG. 7. The systems and methods described can also be implemented using a combination of multiple computer systems as described by FIG. 7.

In one implementation, the computer system 700 includes processing resources 710, a main memory 720, ROM 730, a storage device 740, a communication interface 750, and a display 760. The computer system 700 includes at least one processor 710 for processing information and a main memory 720, such as a random access memory (RAM) or other dynamic storage device, for storing information and instructions to be executed by the processor 710. The main memory 720 also may be used for storing temporary variables or other intermediate information during execution of instructions to be executed by the processor 710. The computer system 700 may also include a read only memory (ROM) 730 or other static storage device for storing static information and instructions for the processor 710. A storage device 740, such as a magnetic disk or optical disk, is provided for storing information and instructions. For example, the storage device 740 can correspond to a computer-readable medium that store instructions performing calibration operations discussed with respect to FIGS. 1-5.

The interface 750 may enable the computer system 700 to detect signals from various network devices 780. As such, UIDs 752 corresponding to such detected network devices 780 can be received and compiled in a UID log 736. Additionally or alternatively, the interface 750 can enable computer system 700 to establish a network link to communicate with host server 790. Using the network link, the computer system 700 can communicate with a plurality of devices. The main memory 720 of the computer system 700 can further store a game application 722, which can be initiated by the processor 710. According to some examples, launch of the game application 722 can cause rendered gameplay 762 to be presented to the user on the display 760.

The computer system 700 can further utilize one or more of main memory 720, ROM 730, or storage device 740 in order to maintain the virtual resource log 732, the association table 734, and the UID log 736. The processor 710 can execute instructions to perform operations described with respect to the association engine 712, the resource engine 714, and/or the UID recorder 716, as described herein.

Examples described herein are related to the use of computer system 700 for implementing the techniques described herein. According to one example, those techniques are performed by computer system 700 in response to processor 710 executing one or more sequences of one or more instructions contained in main memory 720, such as the game application 722. Such instructions may be read into main memory 720 from another machine-readable medium, such as storage device 740. Execution of the sequences of instructions contained in main memory 720 causes processor 710 to perform the process steps described herein. In alternative implementations, hard-wired circuitry and/or hardware may be used in place of or in combination with software instructions to implement examples described herein. Thus, the examples described are not limited to any specific combination of hardware circuitry and software.

Conclusion

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that this disclosure is not limited to those precise examples. As such, many modifications and variations will be apparent to practitioners skilled in this art. Accordingly, it is intended that the scope of this disclosure be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude the inventor from claiming rights to such combinations.

Although illustrative examples have been described in detail herein with reference to the accompanying drawings, variations to specific examples and details are encompassed by this disclosure. It is intended that the scope of the invention is defined by the following claims and their equivalents. Furthermore, it is contemplated that a particular feature described, either individually or as part of an example, can be combined with other individually described features, or parts of other examples. Thus, absence of describing combinations should not preclude the inventor(s) from claiming rights to such combinations.

While certain examples have been described above, it will be understood that the examples described are by way of example only. Accordingly, this disclosure should not be limited based on the described examples. Rather, the scope of the disclosure should only be limited in light of the claims that follow when taken in conjunction with the above description and accompanying drawings.

What is claimed is:

1. A signal identification system comprising:
a detection mechanism to detect wireless signals emitted from network devices when the signal identification system is within range; and
a memory to record and store unique identifiers (UIDs), associated with each of the network devices, in a UID log when the detection mechanism detects a respective wireless signal for a respective network device.

2. The signal identification system of claim 1, wherein the memory further stores association information in an association table, the association table associating UIDs with virtual resources.

3. The signal identification system of claim 2, further comprising:
a processor;
wherein the memory stores instructions that, when executed by the processor, cause the processor to:
when the detection mechanism detects the respective wireless signal, perform a lookup in the association table to determine whether the respective network device is associated with a respective virtual resource.

4. The signal identification system of claim 3, wherein the executed instructions further cause the processor to:
in response to determining that the respective network device is associated with a respective virtual resource, log a specified quantity of the respective virtual resource in a virtual resource log of the memory.

5. The signal identification system of claim 4, wherein the executed instructions further cause the processor to:
in response to determining that the respective network device is not associated with a respective virtual resource, enter an indication in the association table indicating that the respective network device is not associated with a respective virtual resource.

6. The signal identification system of claim 5, wherein the executed instructions further cause the processor to:
connect with a host server over a network, the host server to provide association information corresponding to an association between the respective network device and an associated virtual resource; and
in response to receiving the association information, log a specified quantity of the associated resource in a virtual resource log of the memory.

7. The signal identification system of claim 3, wherein the signal identification system comprises a mobile computing device running a software application specific to at least one of accumulating, consuming, or utilizing the virtual resources in connection with gameplay.

8. The signal identification system of claim 1, wherein the respective network device is one of an access point, a mobile computing device, a tablet computer, a personal computer, a BLUETOOTH enabled device, a radio-frequency identification device, or a local area network enabled device.

9. A non-transitory computer readable medium storing instructions that, when executed by one or more processors of a computing device, cause the one or more processors to:
detect, using a detection mechanism of the computing device, wireless signals emitted from network devices when the computing device is within range; and
record and store, in a memory of the computing device, unique identifiers (UIDs), associated with each of the network devices, in a UID log when the detection mechanism detect a respective wireless signal for a respective network device.

10. The non-transitory computer readable medium of claim 9, wherein the memory further stores association information in an association table, the association table associating UIDs with virtual resources.

11. The non-transitory computer readable medium of claim 10, wherein the executed instructions further cause the one or more processors to:
when the detection mechanism detects the respective wireless signal, perform a lookup in the association table to determine whether the respective network device is associated with a respective virtual resource.

12. The non-transitory computer readable medium of claim 11, wherein the executed instructions further cause the one or more processors to:
in response to determining that the respective network device is associated with a respective virtual resource, log a specified quantity of the respective virtual resource in a virtual resource log of the memory.

13. The non-transitory computer readable medium of claim 12, wherein the executed instructions further cause the one or more processors to:
in response to determining that the respective network device is not associated with a respective virtual resource, enter an indication in the association table indicating that the respective network device is not associated with a respective virtual resource.

14. The non-transitory computer readable medium of claim 13, wherein the executed instructions further cause the one or more processors to:
connect with a host server over a network, the host server to provide association information corresponding to an association between the respective network device and an associated virtual resource; and
in response to receiving the association information, log a specified quantity of the associated resource in a virtual resource log of the memory.

15. The non-transitory computer readable medium of claim 11, wherein the instructions are executed by the computing device in conjunction with running a software application specific to at least one of accumulating, consuming, or utilizing the virtual resources in connection with gameplay.

16. The non-transitory computer readable medium of claim 9, wherein the respective network device is one of an access point, a mobile computing device, a tablet computer, a personal computer, a BLUETOOTH enabled device, a radio-frequency identification device, or a local area network enabled device.

17. A method of associating wireless signal sources with virtual resources, the method performed by one or more processors of a computing device and comprising:
detecting, using a detection mechanism of the computing device, wireless signals emitted from network devices when the computing device is within range; and
recording and storing, in a memory of the computing device, unique identifiers (UIDs), associated with each of the network devices, in a UID log when the detection mechanism detect a respective wireless signal for a respective network device.

18. The method of claim 17, wherein the memory further stores association information in an association table, the association table associating UIDs with virtual resources.

19. The method of claim 18, further comprising:
when the detection mechanism detects the respective wireless signal, performing a lookup in the association table to determine whether the respective network device is associated with a respective virtual resource.

20. The method of claim 11, further comprising:
in response to determining that the respective network device is associated with a respective virtual resource, logging a specified quantity of the respective virtual resource in a virtual resource log of the memory.
